(19) United States
(12) Patent Application Publication
(10) Pub. No.: US 2022/0351184 A1
(43) Pub. Date: Nov. 3, 2022

(54) IN ONLINE TRANSACTIONS A PAYMENT SYSTEM OR A PAYMENT METHOD USING A CREDIT CARD THAT CAN LINK WITH A URL

(71) Applicant: Geum Cheol KIM, Uiwang-si (KR)

(72) Inventor: Geum Cheol KIM, Uiwang-si (KR)

(21) Appl. No.: 17/425,183

(22) PCT Filed: Jan. 23, 2020
(86) PCT No.: PCT/KR2020/001193

§ 371 Date: Jul. 22, 2021

(30) Foreign Application Priority Data
Jan. 26, 2019 (KR) 10-2019-0010212

(51) Int. Cl. G06Q 20/34; G06Q 20/20; G06Q 20/40

(52) U.S. Cl. CPC G06Q 20/353; G06Q 20/20; G06Q 20/401

(57) ABSTRACT

In online payment using the URL&CC, the routes of the payment request process and the user confirmation process are different and the order of these can be changed. (Payment method 1) Payment method 1 first requests payment by using the URL&CC's CCI path, and confirms the user by using the URL&CC's URL path and the user's URL PWD path. (Payment method 2) Payment method 2 confirms the user by using the URL&CC's URL path and the user's URL PWD path, and requests the payment by using the URL&CC's CCI path.

### CROSS-REFERENCE TO RELATED APPLICATIONS

### Technical Field

It is a payment system or a payment method using a credit card in online transactions.

### Discussion of Related Art

(CC=Credit Card) A CC complies with credit card standards, includes CCI, and can support a payment.

In payments using CCs, a payment request's path and a user confirmation's path are the same.

CCs include debit cards and prepaid cards that comply with credit card standards.

(Credit card standards) Credit card standards include ISO-7810, and EMV, etc.

Credit card standards are the basis of credit card business. CCs, store's devices (sales servers, etc.), and card company's devices comply with the credit card standards.

(ISO-7810) ISO-7810 defines shape of CC, information exchange method, specifications of CC terminal, etc.

(EMV) EMV (Europay Master card Visa) is international technical standards for IC type's CCs.

(CCI=Credit Card Information) CCI is information included in CC.

The CCI include main information (card number) or additional information (CVC, expiration date, or others).

In online transactions, CCI is visual information.

In online transactions, CCI is delivered to CC users in visual information.

(Card number) A card number is a CC's 16-digit number.

Numbers from 1st to 6th (BIN number) designate an issuing country, a card company, and a type of card (general, gold, individual, corporation, etc.). Numbers from 7th to 15th are used arbitrarily by a credit card company. The 16th number is a value that verifies the card number.

(CVC, CVV, CID) CVC (Card Verification Code) is a code that verifies a CC's security code or a card holder. A CVC is sometimes called to as a CVV or a CID.

In online transactions, the 3-digit number of CVC and the 16-digit card number must match for a payment.

CVCs prevent the leaked card numbers from being used illegally in online transactions.

(CC user) CC users are the subject of using CCs. CC users provide PI (=Personal Information) to verify identity.

(PI=Personal Information) PI is the personal information of CC user (name, SSN, phone number, or others.).

PI is not included in CCI.

PI is used to verify the identity of a CC user in online transactions.

(Payment Request) A payment request is to request a payment and can include order details, etc.

A payment request is used simultaneously with PI and CCI.

(Order Details) Order details are details to order and can include items, prices, or others.

(Computer) Computer is electronic device that has Internet communication function and information exchange function.

A smart phone can act like a computer.

Computers do not need the ability to communicate with CCs.

(Access order) Access order is a command to connect to a server or website.

(SS=Sales Server) A SS is a sales server of online store.

A SS complies with credit card standards. A SS includes a function to communicate with PICD.

A SS delivers a PICD's PICR, CCI, and a payment request to a CCPS.

(Sales site) Sales site is website that sells goods, services, products, or others. A SS supports a sales site.

(PICD=Personal Information Confirmation Department) A PICD verifies PI.

Since a store cannot verify PI, a payment agency company (=PG company) verifies PI and receives costs.

(PICR=Personal Information Confirmation Result) A PICR is a result of verifying PI.

(CCPS) A CCPS is a server that manages a payment using a CC.

A CCPS pays using the information (CCI, PICR, and a payment request) received through the same path.

(Payment Result) A payment result is a result to pay in response to a payment request.

A payment result of CC is a result to use information (CCI, PICR, and payment request) of the same path.

(A payment method of CC) A CC's payment method uses information (=CCI, PI, and a payment request) of the same path to confirm a CC user and pays.

(A payment request process and a CC user's confirmation process) In the payment request process, a SS receives CCI and PI and a payment request from a CC user. In the CC user verification process, a third party (PG company) delivers the PICR (=the result of verifying a CC user by checking PI) to the SS. And a CCPS makes payment using the information (CCI and PCIR and a payment request) received from the SS.

In payments using CC, the payment request process's path and the CC user confirmation process's path are the same.

(PG company) A PG (Payment Gateway) company is a third party, and receives costs by verifying a PI.

(Problems of single path) Since CCI and PI use the same path, they can be leaked at the same time, and it is difficult to prevent illegal use.

(Regarding path separation: offline transaction's example) In Korean Patent No. 10-1751640 and Korean Patent No. 10-1941587, a payment request's path and a CC user confirmation's path are different and order of the paths can be exchanged.

(Problems of a payment using CC)

1) CCI and PI can be leaked at the same time.

2) There are costs to verify PI.

3) It is difficult to prevent the illegal usage of leaked CCI or PI.

4) For safe transactions, it is necessary to use additional information (CVC, etc.).

5) Additional income cannot be generated.

FIGS. 1 and 2 are an existing system and an existing flow chart for a payment using a CC.

<Existing System for a Payment Using a CC, See FIG. 1>

A credit card's payment system, comprising: a CC that can store CCI and deliver the CCI to a CC user; a computer that can connect to a SS in response to the CC user's access order, communicate a sales site with the SS and the CC user, receive the CCI and PI and a payment request from the CC user, deliver the CCI and the PI and the payment request to the SS, and communicate a payment result with the SS and the CC user; the SS that can connect to the computer, communicate the sales site with the computer, receive the CCI and the PI and the payment request from the computer, deliver the PI to a PICD, receive a PICR from the PICD, deliver the CCI and the PICR and the payment request to a CCPS, and deliver the payment result of the CCPS to the computer; the PICD that can receive the PI from the SS and deliver the PICR to the SS; and the CCPS that can receive the CCI, the PICR and the payment request from the SS and deliver the payment result to the SS in response to the CCI, the PI and the payment request. In the credit card payment system, the payment request process and the CC user confirmation process are performed simultaneously in the same path.

<Existing Method of a Payment Using a CC, See FIG. 2>

A credit card's payment method, comprising: step a) in which a computer connects to a SS in response to a CC user's access order and communicates a sales site with the SS and the CC user; step b) in which a CC delivers CCI to the CC user; step c) in which the computer delivers the CCI, PI, and a payment request of the CC user to the SS; step d) in which the SS delivers the PI to a PICD; step e) in which the PICD delivers a PICR to the SS; step f) in which the SS delivers the CCI, the PICR, and the payment request to a CCPS; step h) in which the CCPS delivers a payment result to the SS; step i) in which the SS delivers the payment result to the computer; and step j) in which the computer delivers the payment result to the CC user. In a credit card's payment method, the payment request process and the user confirmation process are carried out simultaneously through a same path.

### SUMMARY

In online transaction, it provides the following means.

1) A means to identify users without using user's PI (=personal information).

2) A means to prevent the simultaneous leakage of payment information.

3) A means to prevent illegal use of leaked information.

4) A means to reduce the cost of identifying users.

5) A means not to use the additional information (CVC, etc.) of credit card.

6) Economical and efficient a payment system.

7) A means to generate additional income.

In online transactions, a URL&CC, a SD, SD information, a URL&SS, URL&SS information, sales sites, a URL&CCPS, a URL&CCWS, URL&CC sites, CCI, a payment request, order #, order details, a URL, a URL PWD, a URL PWD check result, order confirmation, or a payment result, etc. operates organically to make payments. After requesting payment through a path using CCI, etc., a user is identified through a path using a URL, a URL PWD, or others.

In online transactions, a URL&CC, a SD, SD information, a URL&CCWS, URL&CC sites, a URL&SS, URL&SS information, sales sites, a URL&CCPS, a URL, a URL PWD, a URL PWD check result, a payment reservation, CCI, a payment request, or a payment result, etc. operates organically to make payments. After confirming a user through a path using URL, URL PWD, or others, a payment is requested through a path using CCI, etc.

In online transactions,

1) PI (=Personal information) is not used because a user is identified by using a URL, a URL PWD, etc.

2) Payment information is not leaked at the same time, because a payment request path and a user confirmation path are different.

3) Since the paths can be separated and the usage methods can be specified, the illegal use of the leaked information can be prevented.

4) It is possible to reduce the cost of user confirmation, because the card company's device checks a URL, a URL PWD, or others.

5) Additional information (CVC, etc.) is not used, because a user is identified by a URL, a URL PWD, etc.

6) By separating the paths and specifying the usage methods, a payment security can be provided structurally.

7) Additional income can be generated by using advertisements, etc. in the payment process.

### BRIEF DESCRIPTION OF THE DRAWINGS

FIG. 1 is an existing payment system that uses an existing credit card and uses CCI (=credit card information), PI (=personal information), and a payment request through one path.

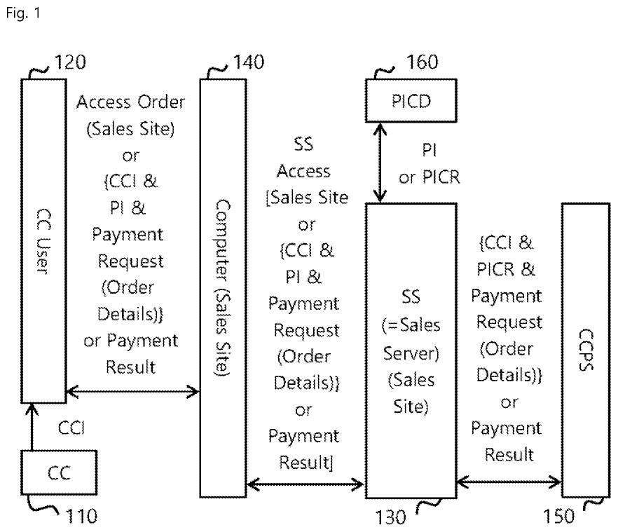

FIG. 2 is a flow chart of FIG. 1.

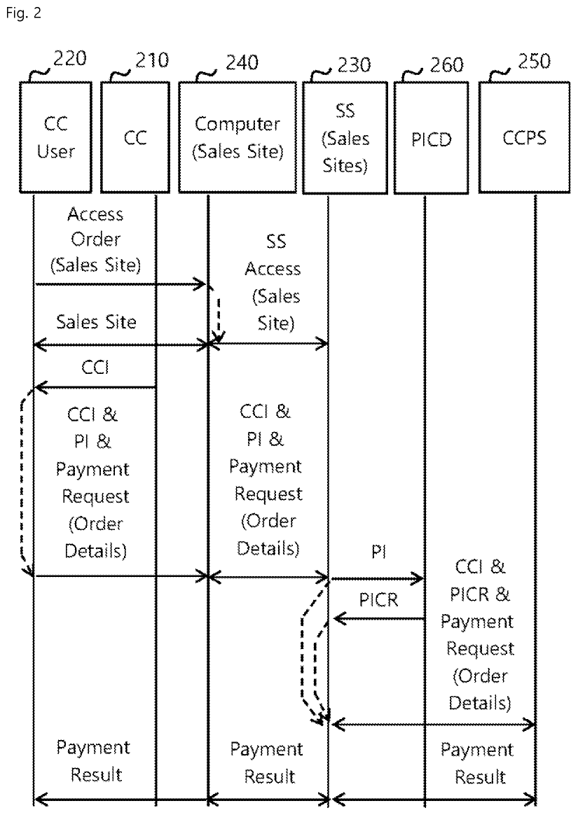

FIG. 3 is a payment system that checks a user through the other path supporting a URL, URL PWD, or others, after requesting a payment through one path supporting CCI, etc.

FIG. 4 is a flow chart of FIG. 3.

FIG. 5 is a payment system that requests a payment through the other path supporting CCI, etc., after checking a user through one path supporting a URL, a URL PWD, or others.

FIG. 6 is a flow chart of FIG. 5.

### DETAILED DESCRIPTION OF EXEMPLARY EMBODIMENTS

Hereinafter, preferred embodiments of the present invention are described in detail with reference to the accompanying drawings. The terms used herein should be interpreted not in typical or dictionary definitions but to comply in concept with the technical matters of the present invention.

The configurations disclosed in the specification and the drawings are mere examples and do not overall represent the technical spirit of the present invention. Therefore, various changes may be made thereto, and equivalents thereof also belong to the scope of the present invention.

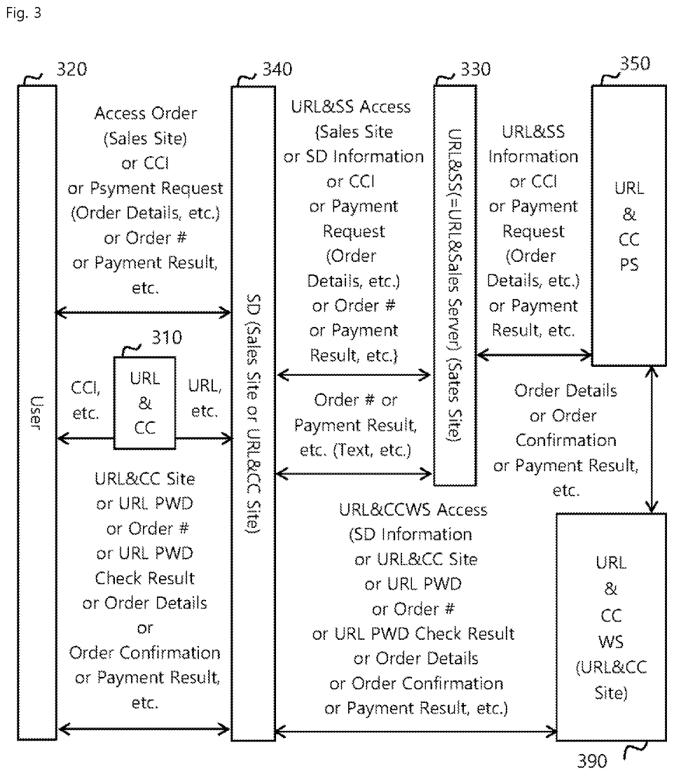

URL (Uniform Resource Locator) is the location of a web document or a file in a web server that provides various services.

<An Online Payment System that Confirms a User after Requesting Payment, See FIG. 3>

An online payment system, comprising: a URL&CC that can store CCI, a URL, etc., deliver CCI to a user, or deliver a URL to a SD; a SD that can connect to a URL&SS in response to a user's access order, communicate a sales site, etc. with a URL&SS or a user, receive CCI, a payment request including order details, or others from a user, deliver CCI, a payment request, or others to a URL&SS, receive an order #, etc. from the URL&SS, deliver an order #, etc. to a user, receive a URL from a URL&CC, connect to a URL&CCWS in response to a URL, communicate SD information, etc. with a URL&CCWS, communicate a URL&CC site, etc. with a URL&CCWS or a user, receive a URL PWD, etc. from a user, deliver a URL PWD, etc. to a URL&CCWS, receive a URL PWD check result, an order details, or others from a URL&CCWS, deliver a URL PWD check result, an order details, or others to a user, deliver a user's an order confirmation, etc. to a URL&CCWS, or deliver a payment result of a URL&SS or URL&CCWS to a user; a URL&SS that can connect to a SD, communicate a sales site, etc. with a SD, receive CCI, a payment request, or others from a SD, deliver an order #, etc. to a SD, deliver URL&SS information, CCI, a payment request, or others to a URL&CCPS, or deliver a URL&CCPS's payment result, etc. to a SD; a URL&CCWS that can receive an order details, etc. from a URL&CCPS, connect to a SD, communicate SD information, a URL&CC site, or others with a SD, receive a URL PWD, etc. from a SD, deliver a URL PWD check result, an order details, or others to a SD, receive an order confirmation, etc. from a SD, deliver an order confirmation, etc. to a URL&CCPS, or deliver a URL&CCPS's payment result, etc. to a SD; or a URL&CCPS that can receive URL&SS information, CCI, a payment request, or others from a URL&SS, deliver an order details, etc. to a URL&CCWS, receive an order confirmation, etc. from a URL&CCWS, or deliver a payment result, etc. to a URL&SS or a URL&CCWS in response to a payment request, an order confirmation, or others. An online payment system confirms a user using a URL&CC's URL, a user's URL PWD, or others after requesting payment using a URL&CC's CCI, etc.

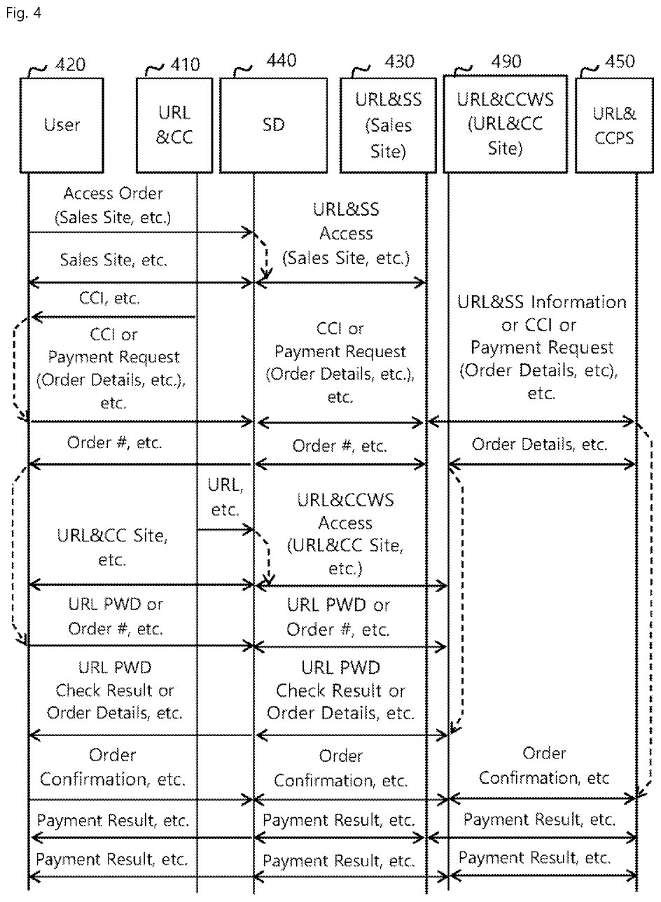

An Online Payment Method that Confirms a User after Requesting Payment, See FIG. 4>

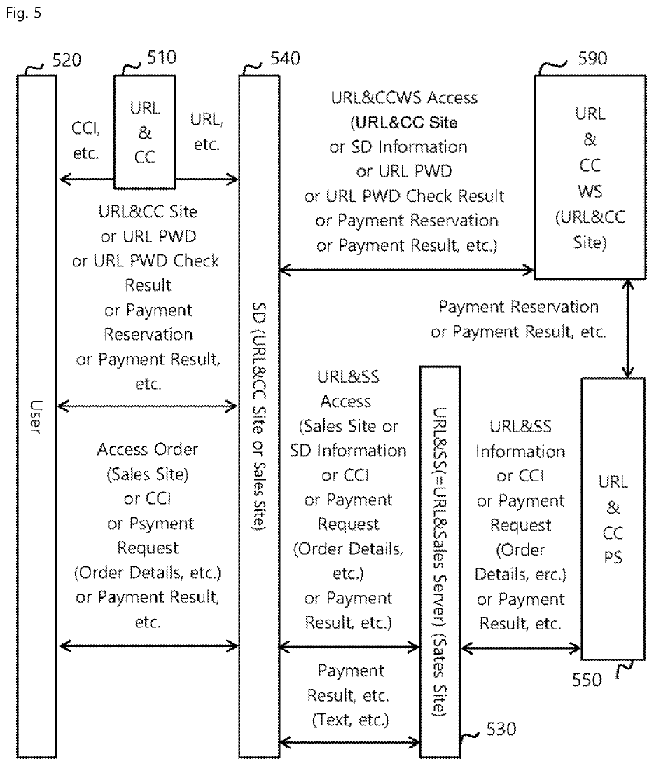

An online payment method, comprising: step a) in which a SD connects to a URL&SS in response to a user's access order, or communicates a sales site, etc. with a URL&SS or a user; step b) in which a URL&CC delivers CCI to a user; step c) in which a SD receives CCI, a payment request including order details, or others from a user, delivers CCI, a payment request, or others to a URL&SS, receive an order #, etc. from a URL&SS, or deliver an order #, etc. to a user; step d) in which a URL&SS delivers URL&SS information, CCI, a payment request, or others to a URL&CCPS; step e) in which a URL&CCPS delivers an order details, etc. to a URL&CCWS; step f) in which a URL&CCWS manages an order details, etc.; step g) in which a SD receives a URL from a URL&CC, connects to a URL&CCWS in response to a URL, communicates SD information, etc. with a URL&CCWS, communicates a URL&CC site, etc. with a URL&CCWS or a user, receives a URL PWD, etc. from a user, delivers a URL PWD, etc. to a URL&CCWS, receives a URL PWD check result, an order details, or others from a URL&CCWS, delivers a URL PWD check result, an order details, or others to a user, receives an order confirmation, etc. from a user, or delivers an order confirmation, etc. to a URL&CCWS; step h) in which a URL&CCWS delivers an order details, etc. to a URL&CCPS; step i) in which a URL&CCPS delivers a payment result, etc. to a URL&SS or a URL&CCWS in response to a payment request, an order confirmation, or others; or step j) in which a URL&SS or a URL&CCWS delivers a payment result, etc. to a SD; or a SD delivers a payment result, etc. to a user. An online payment method confirms a user using a URL&CC's URL, a user's URL PWD, or others after requesting payment using a URL&CC's CCI, etc.

<An Online Payment System that Requests Payment after Confirming a User, See FIG. 5>

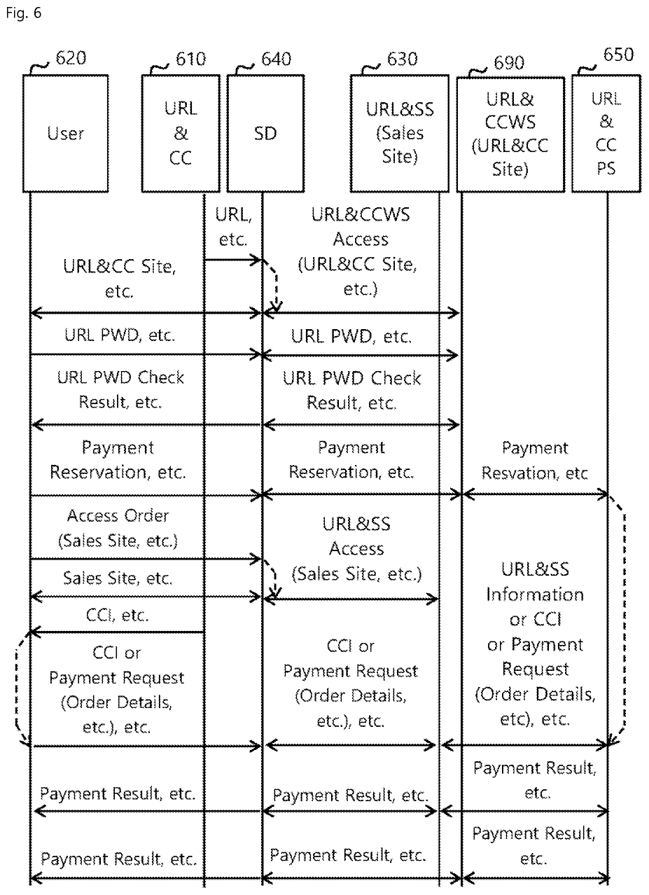

An online payment system, comprising: a URL&CC that can store CCI, a URL, etc., deliver CCI to a user, or deliver a URL to a SD; a SD that can receive a URL from a URL&CC, connect to a URL&CCWS in response to a URL, communicate SD information, etc. with a URL&CCWS, communicate a URL&CC site, etc. with a URL&CCWS or a user, receive a URL PWD, etc. from a user, deliver a URL PWD, etc. to a URL&CCWS, receive a URL PWD check result, etc. from a URL&CCWS, deliver a URL PWD check result, etc. to a user, receive a payment reservations, etc. from a user, deliver a payment reservation, etc. to a URL&CCWS, connect to a URL&SS in response to a user's access order, communicate a sales site, etc. with a URL&SS or a user, receive CCI, a payment request, or others from a user, deliver CCI, a payment request, or others to a URL&SS, receive a payment result, etc. from a URL&CCWS or a URL&SS, or deliver a payment result, etc. to a user; a URL&CCWS that can connect to a SD, communicate SD information, a URL&CC site, or others with a SD, receive a URL PWD, etc. from a SD, deliver a URL PWD check result, etc. to a SD, receive a payment reservation, etc. from a SD, deliver a payment reservation, etc. to URL&CCPS, or deliver a URL&CCPS's a payment result, etc. to a SD; a URL&SS that can connect to a SD, communicate a sales site, etc. with a SD, receive CCI, a payment request, or others from a SD, deliver URL&SS information, CCI, a payment request, or others to a URL&CCPS, or deliver a URL&CCPS's payment result, etc. to a SD; or a URL&CCPS that can receive a payment reservation, etc. from a URL&CCWS, receive URL&SS information, CCI, a payment request, or others from a URL&SS, or deliver a payment result, etc. to a URL&CCWS or a URL&SS in response to a payment reservation, a payment request, or others. An online payment system confirms a user using a URL&CC's URL, a user's URL PWD, or others and then requests payment using a URL&CC's CCI, etc.

<An Online Payment Method that Requests Payment after Confirming a User, See FIG. 6>

An online payment system, comprising: step a) in which a URL&CC delivers a URL to a SD; step b) in which a SD connects to a URL&CCWS in response to a URL, communicates SD information, etc. with a URL&CCWS, communicates a URL&CC site, etc. with a URL&CCWS or a user, receives a URL PWD, etc. from a user, delivers a URL PWD, etc. to a URL&CCWS, receive a URL PWD check result, etc. from a URL&CCWS, deliver a URL PWD check result, etc. to a user, receive a payment reservation, etc. from a user, or deliver a payment reservation, etc. to a URL&CCWS; step c) in which a URL&CCWS delivers a payment reservation, etc. to a URL&CCPS; step d) in which a SD connects to a URL&SS in response to a user's access order, or communicates a sales site, etc. with a URL&SS or a user; step e) in which a URL&CC delivers CCI to a user; step f) in which a SD receives CCI, a payment request, or others from a user, or delivers CCI, a payment request, or others to a URL&SS; step g) in which a URL&SS delivers URL&SS information, CCI, a payment request, or others to a URL&CCPS; step h) in which a URL&CCPS delivers a payment result, etc. to a URL&CCWS or a URL&SS in response to a payment reservation, a payment request, or others; or step i) in which a URL&CCWS or a URL&SS delivers a payment result, etc. to a SD; or a SD delivers a payment result, etc. to a user. An online payment system confirms a user using a URL&CC's URL, a user's URL PWD, or others and then requests payment using a URL&CC's CCI, etc.

### Definition and Explanation of Terms

(URL&CC) A URL&CC is a credit card that includes a URL.

A URL&CC can store CCI, a URL, etc.

CCI is visual information and can be delivery to a user. And a URL is electronic information, image information, or other information and can be delivery to a SD, etc.

A URL&CC does not store a URL PWD.

A URL&CC can help identity a user without using a user's PI (personal information).

A URL&CC can separate a payment request path and a user confirmation path.

A URL&CC complies with credit card standards and stores CCI, a URL, etc. A URL&CC can include URL&debitcards (a kind of debit card), URL&prepaidcards (a kind of prepaid card), or others.

CCI or a URL can be stored in one or more URL&CC.

A URL&CC can help connect to a URL&CCWS, etc. while using a URL as an ID.

A URL&CC can prevent an illegal connection by using access methods, usage methods, access paths, SD's information, or others.

Because URL&CCs do not store URL PWDs, them cannot deliver passwords (=URL PWDs) to URL&CCWSs or URL&CC sites. Since a URL&CC is a card, a loss of the URL&CC(=a loss of an ID) can be easily recognized.

(CCI) CCI of a URL&CC follows credit card standards, but cannot include additional information (CVC, expiration date, etc.).

CCI can be in the form of electronic information, image information, or other information.

CCI of a URL&CC does not include a URL or a URL PWD.

(Card number) A card number of URL&CC can correspond to a card number of existing credit card.

Card number is main information of URL&CC.

(User) A user is a subject that can use a URL&CC.

A user does not use PI (=personal information) to confirm a user's identity. A user can provide a URL PWD, a payment reservation, an order confirmation, or others.

(URL) A URL can support connect to a URL&CCWS or a URL&CC Site.

A URL can be used as an ID of URL&CC or user.

A URL may be stored in a URL&CC in the form of electronic information, image information, or other information.

A URL can be transmitted to an outside through a NFC communication, an image communication, or other communications.

A URL&CCWS does not support an access using a browser.

A URL can prevent an illegal access by using usage methods, access paths, SD's features, or other methods.

Since a URL is transmitted to a SD in electronic communication it cannot be leaked through malicious code, phishing, or other hacking.

URLs can support following means. 1) Means to identify a user without using a user's PI (=personal information) 2) Means to use separate paths (a payment request path and a user confirmation path) 3) Means to prevent the simultaneous leakage of payment information 4) Means not to use additional information (CVC, etc.) 5) Means to make an additional income (advertisement income, etc.), etc.

(URL PWD) A URL PWD is a password that is set in a URL, a URL&CC, a URL&CC Site, or others.

A URL PWD can help confirm users or log in to a URL&CCWS.

Since a URL PWD is not stored in URL&CC it is not leaked even if the URL&CC is lost.

The URL PWD can be multiple.

(URL PWD check result) A URL PWD check result is a result of checking a URL PWD, a URL, SD information, or others. A URL PWD check result can include user check results, log results, or others.

(Order #) Order # is a number representing the order and can designate the order.

Order # can be used as information to identify users, etc.

(Payment request) A payment request can include order details, etc.

(Payment reservation) A payment reservation is a notice in advance that a payment will be requested.

A payment reservation can include results of confirming users, etc.

Payment reservations do not exist in existing payments using existing credit cards.

(Order Details) Order details are the details of order and can include items, prices, or others.

Order details can be included in payment requests.

A URL&CCPS can communicate order details, etc. with a URL&CCWS, etc.

(Order confirmation) Order confirmation is to confirm order details.

Order confirmation can include user confirmations or payment request confirmations or others.

Order confirmation is not available for existing payments using existing credit cards.

(SD=Smart Device) A SD is an electronic device that has an internet communication function, an information exchange function, a function of communication with a URL&CC, etc.

A smart-phone is a typical SD.

A SD can include a computer having a function capable of communicating with a URL&CC, etc.

SD can communicate with a URL&CC by using NFC communication, image communication (camera filming, etc.), or others.

A SD can communicate with a URL&CC, but an existing computer cannot communicate with an existing credit card.

More than one SD can connect to sales sites or URL&CC sites to support payments.

(SD information) SD information is SD's information (a SD's IP, an OS serial number, a MAC address, an IMEI (International Mobile Equipment Identity), etc.). SD information can be used as information that identifies SDs, users, or others.

(Access order) Access order is a command to connect to servers or websites.

(URL&SS) A URL&SS is a sales server of an online store that supports a URL&CC.

A URL&SS can include devices (such as sales sites, etc.) that support transactions using URL&CCs.

A URL&SS does not include a function to communicate with a PICD (Personal Information Confirmation Department).

(URL&SS information) URL&SS information is URL&SS's information (an IP, an OS serial number, a MAC address, etc.). URL&SS information can be used as information to check URL&SSs, operators of URL&SS, or others.

(Sales site) Sales sites are websites that sell goods, services, products, or others.

(URL&CCPS) A URL&CCPS is a server that supports payments using URL&CCs.

A URL&CCPS can determine a payment using information (CCI, payment requests, order confirmations, payment reservations, or others) received through separate paths (a payment request path and a user confirmation path).

A URL&CCPS can communicate CCI, payment requests, payment results, or others with URL&SSs, etc.

A URL&CCPS can communicate information (order details, order confirmations, payment reservations, payment results, or others) with URL&CCWSs, etc.

A URL&CCPS cannot use a URL or a URL PWD.

A URL&CCPS can separate payment paths, use order confirmations or payment reservations or others, or communicate with URL&CCWSs.

(URL&CCWS) A URL&CCWS is a web server that can support payments using URL&CCs.

A URL&CCWS can manage URL&CC Sites, etc., or support payments using a URL, a URL PWD, or others.

A URL&CCWS can manage a URL, a URL PWD, or others, and can identify users using a URL, a URL PWD, SD information, or others. A URL&CCWS can determine to log in to URL&CC sites or communicate information (order details, order confirmations, payment reservations, payment results, or others) with URL&CCPSs, etc.

A URL&CCWS is not available for existing payments using existing credit cards.

(URL&CC Site) URL&CC Sites are websites that can support payments using URL&CCs.

URL&CC Sites can support payments using URL&CCs, URLs, URL PWDs, or others.

URL&CC sites can deliver payment process's information (order details, order confirmations, payment reservations, payment results, or others) or include advertisements, etc.

A URL&CC Site is not available for existing payments using existing credit cards.

(Payment Result) Payment result is a result of performing payments.

Payment results of URL&CC can be generated using a payment request path's information (CCI, payment request, etc.) and a user confirmation path's information (order confirmation, payment reservation, etc.).

Order confirmations or payment reservations do not exist in existing payments using existing credit cards.

(A payment Method 1 using URL&CCs: See FIGS. 3 and 4) After requesting a payment through a path using CCI, etc., a user is identified through a path using a URL, a URL PWD, or others.

(A payment method 2 using URL&CCs: see FIGS. 5 and 6) After confirming users through a path using a URL, a URL PWD, or others a payment is requested through a path using CCI, etc.

A URL&CC's payment request process and user confirmation process have the different path and information.

(Advantages of Payments Using URL&CCs)

1) Since users can be identified with URLs, URL PWDs, etc., PI (=personal information) does not be used.

2) Because CCI uses a payment request path and a URL or a URL PWD uses a user confirmation path, payment information cannot be leaked at the same time.

3) Since a URL of URL&CC can specify an access method, an access path or others, an illegal access to a URL&CCWS can be prevented.

4) Since a card company's server identifies users by using URLs, URL PWDs, or others it is possible to reduce costs of user confirmations.

5) Different information for each route and route separation can provide economical security of payments.

6) In payment processes, additional incomes can be generated by using advertisements, etc.

### EXPLANATION OF THE SIGN

<Existing Credit Card Payment System and Flow Chart>
110, 210: CC(=Credit Card)
120, 220: CC User (=Credit Card User)
130, 230: SS(=Sales Server)
140, 240: Computer
150, 250: CCPS(=Credit Card payment Server)
160, 260: PICD (=Personal Information Confirmation Department)
<Invention's URL&CC payment system and flow chart>
310, 410, 510, 610: URL&CC(=URL & Credit Card)
320, 420, 520, 620: User
330, 430, 530, 630: URL&SS(=URL & Sales Server)
340, 440, 540, 640: SD (=Smart Device)
350, 450, 550, 650: URL&CCPS(=URL & Credit Card Payment Server)
390, 490, 590, 690: URL&CCWS(=URL & Credit Card Web Server)

What is claimed is:

1. An online payment system, comprising:
a URL&CC that can store CCI and a URL, deliver the CCI to a user, and deliver the URL to a SD;
the SD that can connect to a URL&SS in response to the user's access order, communicate a sales site, etc. with the URL&SS or the user, receive the CCI and a payment request including order details from the user, deliver the CCI and the payment request to the URL&SS, receive the URL from the URL&CC, connect to a URL&CCWS in response to the URL, communicate SD information, etc. with the URL&CCWS, communicate a URL&CC site, etc. with the URL&CCWS or the user, receive a URL PWD from the user, deliver the URL PWD to the URL&CCWS, receive a URL PWD check result, the order details, etc. from the URL&CCWS, deliver the URL PWD check result, the order details, etc. to the user, deliver the user's an order confirmation to the URL&CCWS, and deliver a payment result of the URL&SS or the URL&CCWS to the user;
the URL&SS that can connect to the SD, communicate the sales site, etc. with the SD, receive the CCI and the payment request from the SD, deliver the CCI, the payment request, etc. to a URL&CCPS, and deliver the URL&CCPS's the payment result to the SD;
the URL&CCWS that can receive the order details, etc. from the URL&CCPS, connect to the SD, communicate the SD information, the URL&CC site, etc. with the SD, receive the URL PWD from the SD, deliver the URL PWD check result, the order details, etc. to the SD, receive the order confirmation from the SD, deliver the order confirmation to the URL&CCPS, and deliver the URL&CCPS's the payment result to the SD; and
the URL&CCPS that can receive the CCI, the payment request, etc. from the URL&SS, deliver the order details, etc. to the URL&CCWS, receive the order confirmation from the URL&CCWS, and deliver the payment result to the URL&SS or the URL&CCWS in response to the payment request, the order confirmation, etc.

2. An online payment method, comprising:
step a) in which a SD connects to a URL&SS in response to a user's access order, and communicates a sales site, etc. with the URL&SS or the user;
step b) in which a URL&CC delivers CCI to the user;
step c) in which the SD receives the CCI and a payment request including order details from the user, and delivers the CCI and the payment request to the URL&SS;
step d) the URL&SS delivers the CCI, the payment request, etc. to the URL&CCPS;
step e) the URL&CCPS delivers the order details, etc. to a URL&CCWS;
step f) the URL&CCWS manages the order details, etc.;
step g) the SD receives a URL from the URL&CC, connects to the URL&CCWS in response to the URL, communicates SD information, etc. with the URL&CCWS, communicates a URL&CC site, etc. with the URL&CCWS or the user, receives a URL PWD from the user, delivers the URL PWD to the URL&CCWS, receives a URL PWD check result, the order details, etc. from the URL&CCWS, delivers the URL PWD check result, the order details, etc. to the user, receives an order confirmation from the user, and delivers the order confirmation to the URL&CCWS;
step h) in which the URL&CCWS delivers the order confirmation to the URL&CCPS;
step i) in which the URL&CCPS delivers the payment result to the URL&SS or the URL&CCWS in response to the payment request, the order confirmation, etc.; and
step j) in which the URL&SS or the URL&CCWS delivers the payment result to the SD; and the SD delivers the payment result to the user.

3. An online payment system, comprising:
a URL&CC that can store CCI and a URL, deliver the CCI to a user, and deliver the URL to a SD;
the SD that can receive the URL from the URL&CC, connect to a URL&CCWS in response to the URL, communicate SD information, etc. with the URL&CCWS, communicate a URL&CC site, etc. with the URL&CCWS or the user, receive a URL PWD from the user, deliver the URL PWD to the URL&CCWS, receive a URL PWD check result, etc. from the URL&CCWS, deliver the URL PWD check result, etc. to the user, receive a payment reservations from the user, deliver the payment reservation to the URL&CCWS, connect to a URL&SS in response to the user's access order, communicate a sales site, etc. with the URL&SS or the user, receive the CCI and a payment request from the user, deliver the CCI and the payment request to the URL&SS, receive a payment result from the URL&CCWS or the URL&SS, and deliver the payment result to the user;
the URL&CCWS that can connect to the SD, communicate the SD information, the URL&CC site, etc. with the SD, receive the URL PWD from the SD, deliver the URL PWD check result, etc. to the SD, receive the payment reservation from the SD, deliver the payment reservation, etc. to URL&CCPS, and deliver the URL&CCPS's the payment result to the SD;
the URL&SS that can connect to the SD, communicate the sales site, etc. with the SD, receive the CCI and the payment request from the SD, deliver the CCI, the payment request, etc. to the URL&CCPS, and deliver the URL&CCPS's the payment result to the SD; and
the URL&CCPS that can receive the payment reservation, etc. from the URL&CCWS, receive the CCI, the payment request, etc. from the URL&SS, and deliver the payment result to the URL&CCWS or the URL&SS in response to the payment reservation, the payment request, etc.

4. An online payment system, comprising:
step a) in which a URL&CC delivers a URL to a SD;
step b) in which the SD connects to a URL&CCWS in response to the URL, communicates SD information, etc. with the URL&CCWS, communicates a URL&CC site, etc. with the URL&CCWS or the user, receives a URL PWD from the user, delivers the URL PWD to the URL&CCWS, receive a URL PWD check result, etc. from the URL&CCWS, deliver the URL PWD check result, etc. to the user, receive a payment reservation from the user, and deliver the payment reservation to the URL&CCWS;
step c) in which the URL&CCWS delivers the payment reservation, etc. to a URL&CCPS;
step d) in which the SD connects to a URL&SS in response to the user's access order, and communicates a sales site, etc. with the URL&SS or the user;
step e) in which the URL&CC delivers CCI to the user;
step f) in which the SD receives the CCI and a payment request from the user, and delivers the CCI and the payment request to the URL&SS;
step g) in which the URL&SS delivers the CCI, the payment request, etc. to the URL&CCPS;
step h) in which the URL&CCPS delivers a payment result to the URL&CCWS or the URL&SS in response to the payment reservation, the payment request, etc.; and
step i) in which the URL&CCWS or the URL&SS delivers the payment result to the SD; and the SD delivers the payment result to the user.
